(19) United States
(12) Patent Application Publication
(10) Pub. No.: US 2014/0227658 A1
(43) Pub. Date: Aug. 14, 2014

(54) Handheld tray for supplying porcelain to a dentist

(71) Applicant: Douglas Halkyard, Morris, IL (US)

(72) Inventor: Douglas Halkyard, Morris, IL (US)

(21) Appl. No.: 13/815,219

(22) Filed: Feb. 11, 2013

(51) Int. Cl. A61C 19/00

(52) U.S. Cl. CPC A61C 19/006
USPC 433/77

(57) ABSTRACT

A device 10 held and supported by one hand of a dentist's assistant to supply porcelain and other compounds 14 to a dentist, includes a cover member 16 that is held open by the same hand of the assistant that supports the device 10 to ultimately allow access by a dentist to the compounds 14 disposed upon a tray member 12. The cover member 16 is allowed to return to a closed position by the supporting hand of the assistant after the dentist has removed a selected compound 14 from the tray member 12, thereby preventing light from activating the compounds 14 while allowing the other hand of the assistant to perform other tasks required by the dentist.

This application is based on U.S. Provisional application No. 61/598,177, filed on Feb. 13, 2012.

### BACKGROUND OF THE INVENTION

1. Field of the Invention

This invention relates to a dentist's device for providing compounds to a dentist while an assistant supports the device with one hand such that the assistant can position a cover member of the device with the same hand to allow the dentist access to the compounds disposed upon a tray member, while allowing the other hand of the assistant to perform other tasks required by the dentist.

2. Background of the Prior Art

A dentist and an assistant perform a myriad of services for a patient reclined in a dentist's chair. One of the more common services is inserting a pliable “filling material” or compound into a tooth to replace a previously removed decaying portion of the tooth. Generally, the compound is disposed on a tray adjacent to the patient, whereupon, the assistant continually provides the dentist with relatively small portions of the compound until the dentist “rebuilds” the tooth to its original return to its normal function.

The problem with the prior art method of “filling a tooth” is that the pliable compound can be excessively exposed to light, thereby activating and degrading the compound such that the integrity of the compound is compromised after it hardens.

The problem is solved by limiting the exposure of the compound to light while the dentist and his or her assistant work to insert the filling material into the tooth. The ultimate goal is to not only limit light exposure, but at the same time, to allow the dentist's assistant to hold a light reducing enclosure containing the compound with one hand, while allowing the assistant's unencumbered hand to utilize an instrument that ultimately collects the compound from inside the enclosure.

### SUMMARY OF THE INVENTION

It is a principle object of the present invention to provide a dentist's device for providing compounds to a dentist such that light is restricted or prevented from engaging the compounds. A feature of the device is a material of construction that restricts or prevents light from engaging the compounds. An advantage of the device is that the compound therein is prevented from being activated by ambient light.

Another object of the present invention is to provide a dentist's device that a dentist's assistant can support with one hand. Another object of the present invention is to provide a dentist's device that the assistant can support and at the same time operate a cover member with one hand. A feature of the device is a lever member and a finger portion that cooperate to allow the assistant to support the device while opening and closing the cover member with one hand. An advantage of the device is that the assistant's other hand is free to manipulate other instruments such as an air/water syringe or a suction device as the assistant supports the tray device and maintains the cover member in an open position by pressing upon the lever member. Another advantage of the device is that the cover member is biased in a closed position, thereby allowing the assistant to return the cover member to a closed position by releasing the lever member.

Yet another object of the present invention is to facilitate the removal of the compounds from the device by the dentist without the aid of the assistant. A feature of the device is that the cover member can be maintained in an open position by sufficiently depressing the lever member to force a hook member to forcibly engage a cooperating retaining member. An advantage of the device is that the cover member is allowed to return to the closed position by manually urging a release lever secured to the hook member in a generally upward direction.

Briefly, the invention provides a dentist device for providing compounds to a dentist while an assistant supports the device with one hand such that the assistant can position a cover member of the device with the same hand to allow the dentist access to the compounds comprising:

a tray member for receiving preselected compounds thereupon;

a cover member for preventing light from engaging the compounds, said cover member being pivotally secured to said tray member;

a support member secured to said tray member, said support member removably receiving a first portion of a first hand of a dentist's assistant supporting said tray member, said support member allowing the assistant to maintain said tray member in a substantially horizontal position, thereby maintaining the positions of the compounds disposed upon said tray member; and

a lever member secured to said cover member such that a second portion of the first hand of the dentist's assistant is allowed to engage said lever member to ultimately urge said cover member to open and closed positions while said first portion of the assistant's first hand supports said tray member via said support member, whereby a second hand of the assistant is capable of removing portions of the preselected compounds while said cover member is maintained open by the first portion of the assistant's first hand until portions of the compounds are removed from said tray member, whereupon, said cover member is re-disposed to a closed positioned by the first portion of the assistant's first hand immediately after the portions of the compounds are removed from said tray member, thereby minimizing the quantity of light engaging the preselected compounds portions remaining on said tray member.

### BRIEF DESCRIPTION OF THE DRAWINGS

FIG. 1 is a perspective view of a handheld device for supplying porcelain and other compounds to dentist in accordance with the present invention. The device includes a cover in a closed position.

FIG. 2 is an exploded view of the device of FIG. 1.

FIG. 3 is a perspective view of the device of FIG. 1, but with a cover that is not transparent.

FIG. 4 is a perspective view of the device of FIG. 3, but with the cover in an open position.

FIG. 5 is a perspective view of the device of FIG. 1, but with an insert removed.

FIG. 6 is a perspective view of the device of FIG. 5, but with the cover member in an open position.

FIG. 7 is a perspective view of the device of FIG. 1, but with a support member separated from a tray member.

FIG. 8 is a front elevation view of the device of FIG. 1.

FIG. 9 is a side elevation view of the device of FIG. 1.

FIG. 10 is a side elevation view of the device of FIG. 9, but with the cover member in an open position.

FIG. 11 is a front elevation view of the device of FIG. 8, but with elements added that maintain the cover member in an open position.

FIG. 12 is a side elevation view of the device of FIG. 11.

FIG. 13 is a side elevation view of the device of FIG. 12, but with the cover member in a maintained open position.

### DESCRIPTION OF THE PREFERRED EMBODIMENT

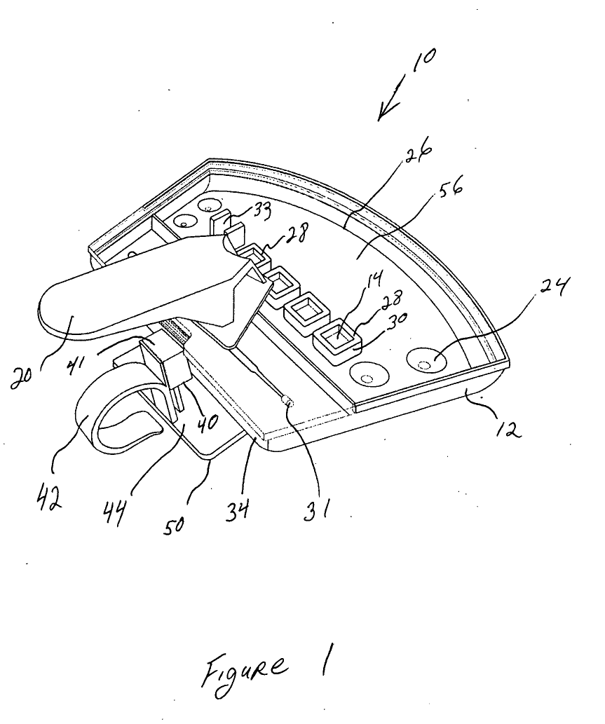

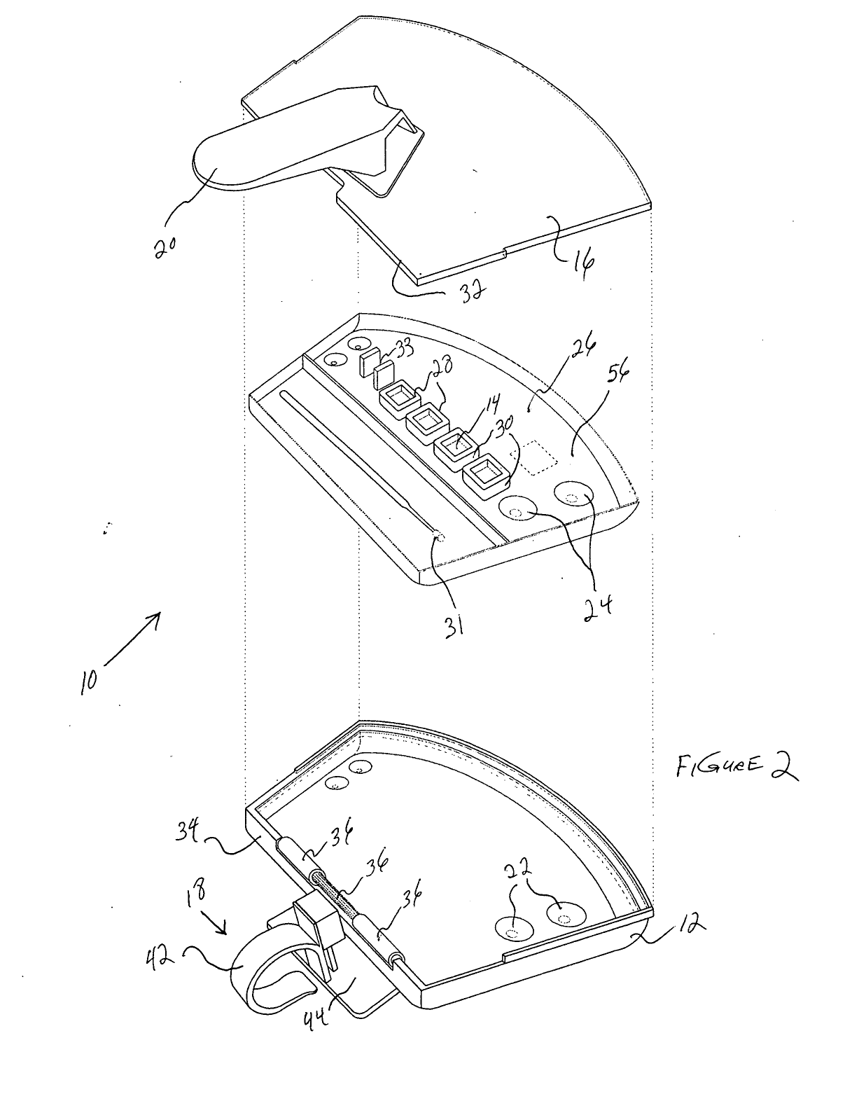

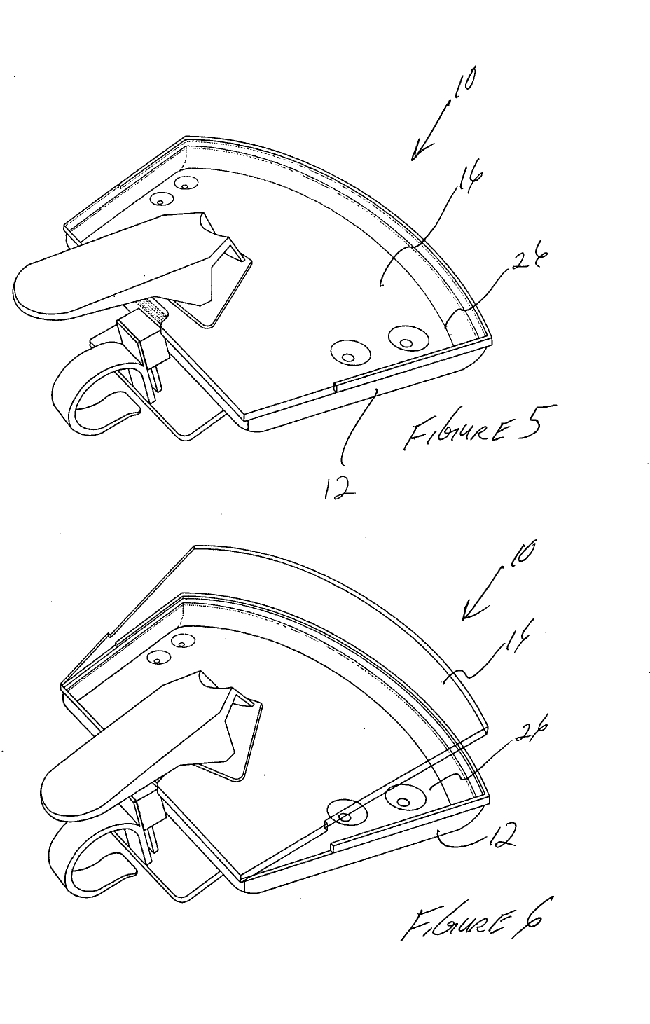

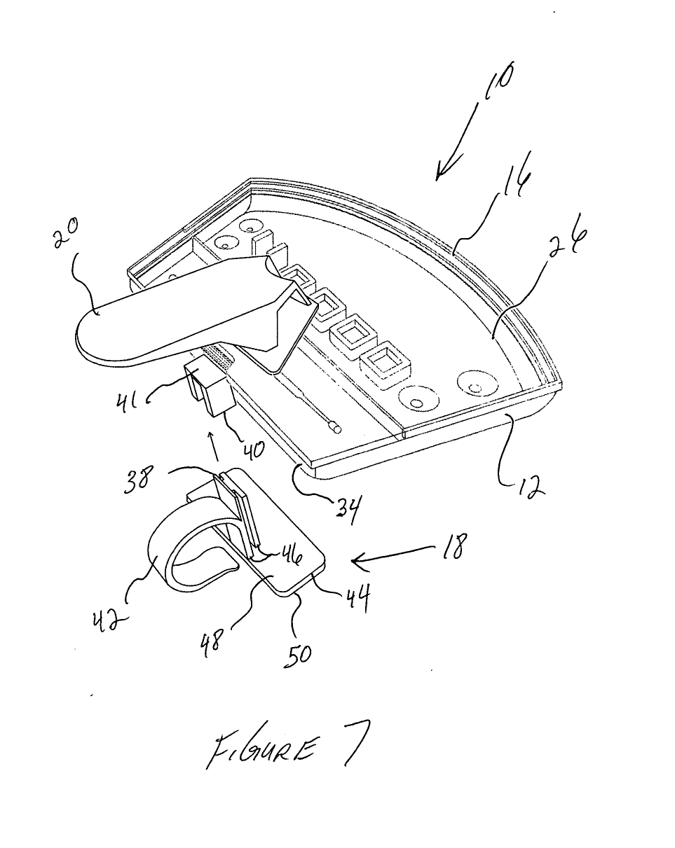

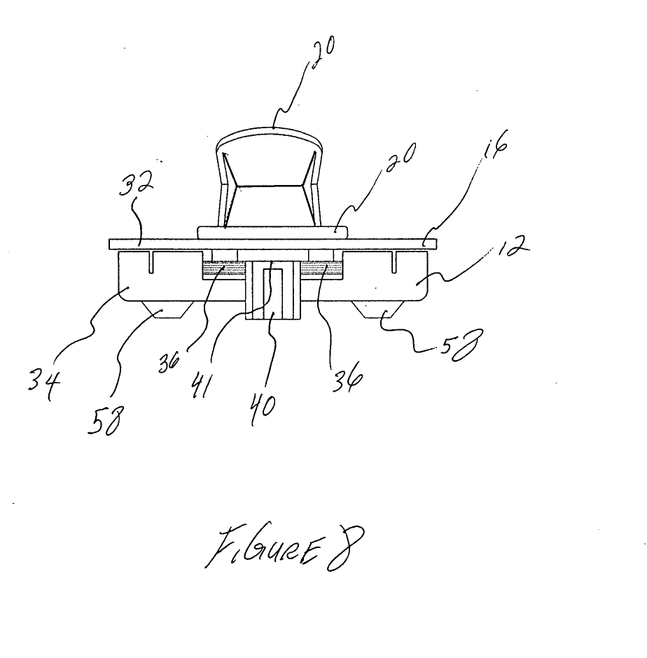

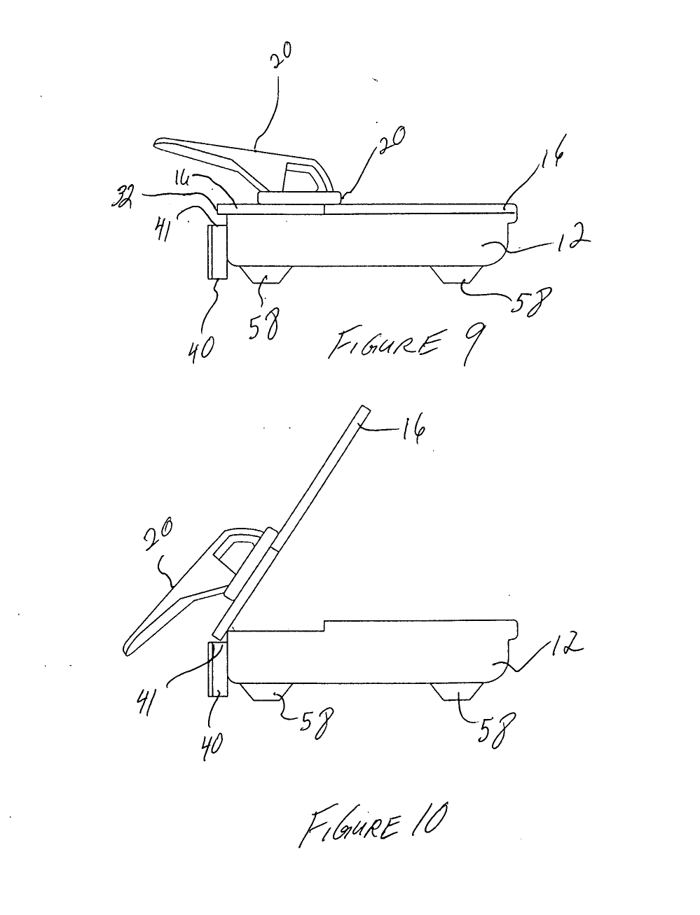

Referring now to the FIGS. 1-10, a dentist's device for providing compounds to a dentist while an assistant supports the device with one hand such that the assistant can position a cover member of the device with the same hand to allow the dentist access to the compounds disposed upon a tray member is denoted by numeral 10. The device 10 includes a tray member 12 for receiving preselected compounds 14 thereupon, and a cover member 16 for preventing light from engaging the compounds 14, the cover member 16 being pivotally secured to the tray member 12. The device 10 further includes a support member 18 secured to the tray member 12. The support member 18 removably receives a first portion of a first hand of a dentist's assistant supporting the tray member 12. The support member 18 allows the assistant to maintain the tray member 12 in a substantially horizontal position, thereby maintaining the positions of the compounds disposed upon the tray member 12.

The device 10 also includes a lever member 20 secured to the cover member 16 such that a thumb or second portion of the first hand of the dentist's assistant is allowed to engage the lever member 20 to ultimately urge the cover member 16 to open and closed positions while the first portion of the assistant's first hand supports said tray member 12 via said support member 18; whereby a second hand of the assistant is free to manipulate other instruments such as an air/water syringe or a suction device as the assistant supports the tray device and maintains the cover member in an open position by pressing upon the lever member 20, while the dentist removes portions of the compounds 14 from the tray member 12. The cover member 16 is ultimately re-disposed upon the tray member 12 in a closed positioned via movement of the assistant's thumb of the first hand immediately after the portions of the compounds 14 are removed from the tray member 12, thereby minimizing the quantity of light engaging and degrading the preselected compounds 14 remaining on the tray member 12.

The tray member 12, cover member 16, support member 18 and lever member 20 may be fabricated from metal, but preferably from a relatively light weight, rigid plastic material to allow a dentist's assistant to manually support the device 10 for relatively long periods of time. The tray member 12 includes a substantially planar surface 13 with recesses 22 to receive and to maintain separated the preselected compounds 14. The recesses 22 may also be used to receive cooperating lower protuberances 24 of a removable insert tray 26 that maintain the position of the insert 26 upon the tray member 12 while the dentist removes portions of the preselected compounds 14 disposed within boxes 28 having walls 30 extending sufficiently vertical above the planar surface 13 of said tray member 12, such that a predetermined quantity of each preselected compound 14 is received and maintained separate from adjacently disposed preselected compounds 14. The tray member 12 may be sized to receive only relatively small portions of the compounds 14, or may be increased in size to receive selected dentist's tools 31 for removing the compounds 14 from the tray member 12 and to receive cotton swabs 33 for application to patients.

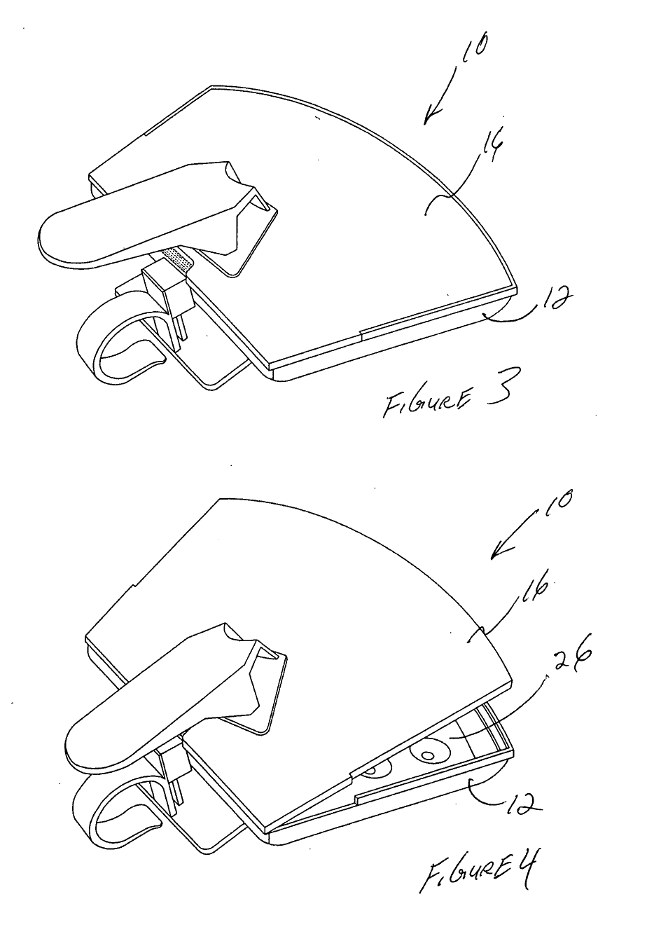

The cover member 16 includes a first end portion 32 pivotally secured to a first end portion 34 of said tray member 12 via a hinge member 36, which is well known to those of ordinary skill in the art. The cover member 16 prevents light from activating or otherwise degrading the compounds 14. In a preferred embodiment, the cover member 16 may be manufactured from a translucent and/or transparent material (see FIGS. 1 and 5-7) that limits the quantity of light engaging the compounds 14, thereby preventing the light from activating the compounds 14 while at the same time allowing the dentist and/or assistant to see and ascertain the quantity of compounds 14 remaining on the tray member 12 without lifting the cover member 16 and exposing the compounds 14 to quantities light, which could activate the compounds 14 even if the compounds 14 are exposed for only a relatively short time period. Alternatively, the cover member 16 can be manufactured from materials (see FIGS. 3 and 4) that prevent any and all light from engaging the compounds 14 when the cover member 16 is closed.

The support member 18 includes a ridge portion 38 that slidably inserts into a cooperating channel portion 40 until engaging a stopping end 41, resulting in the detachable joining of the support member 18 to the first end portion 34 of the tray member 12. The detachable joining of the support member 18 allows the device 10 to be supported by the dentist's assistant at an elevation conducive for the dentist to extract the compounds 14 from the device. Alternatively, when the support member 18 is separated from the tray member 12, the tray member 12 can be disposed upon a work surface adjacent to a patient such that rubber foot members 58 attached to the bottom of the tray member 12, maintain the position of the tray member 12 upon the work surface, thereby allowing the dentist to remove the compounds 14 or tools 31 from the insert tray 26 without the aid of the assistant.

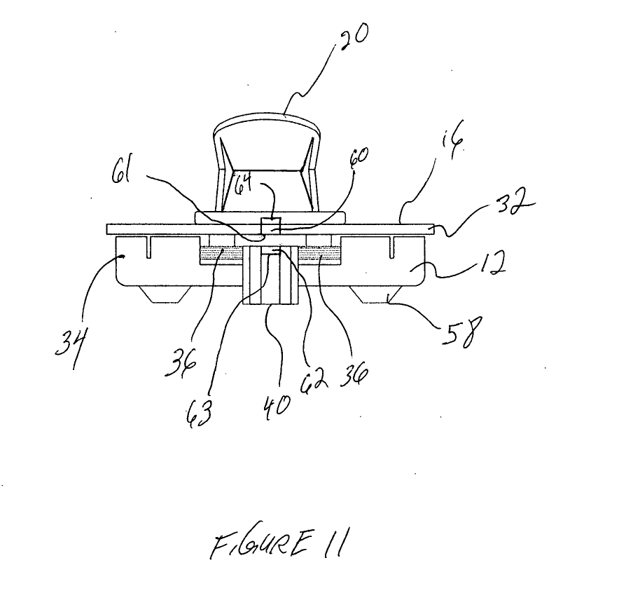

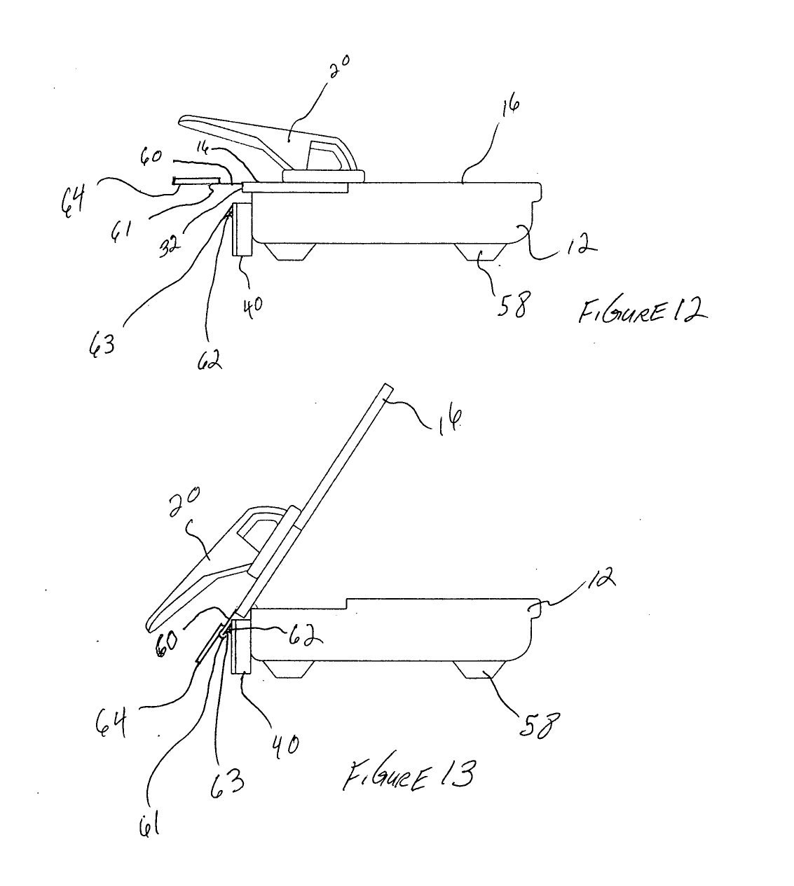

Referring to now FIGS. 11-13, to better facilitate the removal of the compounds 14 and tools 31 by the dentist without the aid of the assistant, the cover member 16 can be maintained in an open position by sufficiently depressing the lever member 20 to cause a flexible (plastic), arcuate hook member 60 secured to the first end portion 32 of the cover member 16 to forcibly engage a cooperating arcuate retaining member 62, which is fabricated from plastic and secured to the channel portion 40 which is attached to first end 34 of the tray member 12. The opening motion of the cover member 16 ultimately forces cooperating tip portions 61 and 63 of the respective hook and retaining members 60 and 62 to become detachably joined, thereby maintaining the open position of the cover member 16 relative to the tray member 12. The cover member 16 is allowed to return to the closed position by manually urging a release lever 64 secured to the hook member 60 in a generally upward direction such that the cooperating tip portions 61 and 63 are separated a distance sufficient to allow the hook member 60 to detach from the retaining member 62, thereby allowing the cover member 16 to “fall” upon the tray member 12.

Referring again to FIGS. 1-10, the support member 18 further includes an annular finger portion 42 for receiving a finger of a first hand of the dentist's assistant. The finger portion 42 is configured and secured to the ridge portion 38 of the support member 18 such that the finger portion 42 is substantially horizontally adjacent to the first end portion 34 of the tray member 12, the finger portion 42 ultimately receiving the index finger of the first hand of the dental assistant. Also, the support member 18 includes a stabilizing portion 44 that is secured to an end portion 46 of the ridge portion 38; the stabilizing portion 44 having upper and lower planar, rectangular surfaces 48 and 50 that are substantially horizontally disposed when the device 10 is held by the assistant for the dentist.

The lower surface 50 of the stabilizing portion 44 has sufficient surface area and is disposed to allow the middle finger of the assistant to comfortably engage the lower surface 50 while the assistant's index finger comfortably inserts through the finger portion 42 and the thumb of the assistant engages the lever member 20. The index and middle fingers of the assistant cooperate to support the tray member 12 in a substantially horizontal position, while the cover member 16 is pivotally elevated about the first end portion 32 to an open position by the thumb of the assistant pressing downward on the lever member 20, thereby allowing the dentist to remove portions of the preselected compounds 14 from the tray member 12. As soon as the dentist removes portions of the compounds 14 from the periphery of the tray member 12, the assistant positions their thumb upward to allow the cover member 16 to drop to a closed position due to the weight distribution of the cover member 16 above the tray member 12 being greater than the weight distribution of the lever member 20 outside the periphery of the tray member 12, resulting in a moment about the hinge member 36 that urges the cover member 16 to engage the tray member 12 when the assistant disposes the tray member 12 in a horizontal position below the cover member 16.

The removable insert tray 26 allows the assistant to quickly “clean” the tray member 12 of preselected compounds 14 when a project is completed by simply removing and discarding the used insert tray 26 and placing a new insert tray 26 upon the tray member 12, which then receives new portions of the preselected compounds 14 thereupon. The insert tray 26 further includes boxes 52 having dimensions varying from the boxes 13 discussed above with walls 54 extending sufficiently vertical above the planar surface 56 of the insert tray 26 such that a predetermined quantity of a preselected compound 14 is received and maintained separate from adjacently disposed preselected compounds 14.

1. A dentist device for providing compounds to a dentist while an assistant supports the device with one hand such that the assistant can position a cover member of the device with the same hand to allow the dentist access to the compounds comprising:
a tray member for receiving preselected compounds thereupon;
a cover member for preventing light from engaging the compounds, said cover member being pivotally secured to said tray member;
a support member secured to said tray member, said support member removably receiving a first portion of a first hand of a dentist's assistant supporting said tray member, said support member allowing the assistant to maintain said tray member in a substantially horizontal position, thereby maintaining the positions of the compounds disposed upon said tray member; and
a lever member secured to said cover member such that a second portion of the first hand of the dentist's assistant is allowed to engage said lever member to ultimately urge said cover member to open and closed positions while said first portion of the assistant's first hand supports said tray member via said support member, whereby a second hand of the assistant is free to manipulate other instruments while said cover member is maintained open by the first portion of the assistant's first hand until portions of the compounds are removed from said tray member, whereupon, said cover member is re-disposed to a closed positioned by the first portion of the assistant's first hand immediately after the portions of the compounds are removed from said tray member, thereby minimizing the quantity of light engaging the preselected compounds portions remaining on said tray member.

2. The device of claim 1 wherein said tray member includes a substantially planar surface with recesses to receive and to maintain separated the preselected compounds.

3. The device of claim 1 wherein said cover member includes a first end portion hinged to a first end portion of said tray member.

4. The device of claim 1 wherein said cover member prevents light from engaging the preselected compounds on said tray member.

5. The device of claim 4 wherein said cover member is manufactured from a translucent material that prevents light from activating the preselected compounds on said tray member.

6. The device of claim 1 wherein said support member includes means for detachably joining said support member to said tray member.

7. The device of claim 6 wherein said detachable joining means includes a ridge portion of said support member that slidably inserts into a cooperating channel portion secured to a first end portion of said tray member.

8. The device of claim 7 wherein said support member includes an annular finger portion for receiving a finger of a first hand of the dentist's assistant.

9. The device of claim 8 wherein said finger portion is configured and secured to said ridge portion of said support member such that the index finger of the first hand of the assistant ultimately inserts through said finger portion.

10. The device of claim 9 wherein said finger portion is ultimately secured to said ridge portion of said support member such that said finger portion is substantially horizontally adjacent to a first end portion of said tray member.

11. The device of claim 10 wherein said support member includes a stabilizing portion secured to an end portion of said channel portion, thereby allowing the middle finger of the first hand of the assistant to engage said stabilizing portion to maintain said tray member in a substantially horizontal position while the dentist removes portions of the preselected compounds from said tray member.

12. The device of claim 1 wherein said lever member includes a first portion secured to said cover member, and a second portion extending outside the periphery of a first end portion of said cover member, thereby allowing a thumb of a first hand of a dentist's assistant to engage and pivot said lever member to an open position that promotes the removal of portions of the preselected compounds disposed upon said tray member by a dentist.

13. The device of claim 12 wherein said second portion of said lever member extends sufficiently outside the periphery of said first end portion of said cover member to allow the thumb of the assistant to maintain the open position of said cover member, while the index finger of the assistant engages said annular finger portion of said support member and the middle finger of the assistant engages said stabilizing portion of said support member, thereby promoting cooperation between the thumb, index finger and middle finger of an assistant's hand to maintain said tray member in a substantially horizontal position while maintaining said cover member in an open position that allows the dentist to remove portions of the preselected compounds disposed upon said tray member.

14. The device of claim 1 wherein said tray member includes a removable insert tray for receiving the preselected compounds thereupon such that when a project is completed, said removable insert tray is discarded and a replacement removable insert tray is disposed upon said tray member to receive new portions of the preselected compounds thereupon.

15. The device of claim 14 wherein said removable insert tray includes means for maintaining the relative position of said insert tray upon said tray member.

16. The device of claim 15 wherein said position maintaining means includes lower protuberances that ultimately insert into recesses in said tray member.

17. A handheld dentist's tray comprising:
a tray member for receiving preselected compounds thereupon;
a cover member for preventing light from engaging the compounds, said cover member being pivotally secured to said tray member;
a support member secured to said tray member, said support member removably receiving a first portion of a first hand of a dentist's assistant supporting said tray member, said support member allowing the assistant to maintain said tray member in a substantially horizontal position, thereby maintaining the positions of the compounds disposed upon said tray member; and
a lever member secured to said cover member such that a second portion of the first hand of the dentist's assistant is allowed to engage said lever member to ultimately urge said cover member to open and closed positions while said first portion of the assistant's first hand supports said tray member via said support member, said lever member including a first portion secured to said cover member, and a second portion extending outside the periphery of a first end portion of said cover member, thereby allowing a thumb of a first hand of a dentist's assistant to engage and pivot said lever member to an open position that promotes the removal of portions of the preselected compounds disposed upon said tray member by a dentist, whereby a second hand of the assistant is free to manipulate other instruments while said cover member is maintained open by the first portion of the assistant's first hand until portions of the compounds are removed from said tray member, whereupon, said cover member is re-disposed to a closed positioned by the first portion of the assistant's first hand immediately after the portions of the compounds are removed from said tray member, thereby minimizing the quantity of light engaging the preselected compounds portions remaining on said tray member.

18. The device of claim 17 wherein said second portion of said lever member extends sufficiently outside the periphery of said first end portion of said cover member to allow the thumb of the assistant to maintain the open position of said cover member, while the index finger of the assistant engages said annular finger portion of said support member and the middle finger of the assistant engages said stabilizing portion of said support member, thereby promoting cooperation between the thumb, index finger and middle finger of an assistant's hand to maintain said tray member in a substantially horizontal position while maintaining said cover member in an open position that allows the dentist to remove portions of the preselected compounds disposed upon said tray member.

19. A tray device for dentists comprising:
a tray member for receiving preselected compounds thereupon;
a cover member for preventing light from engaging the compounds, said cover member including means for maintaining said cover member in an open position;
a support member secured to said tray member, said support member removably receiving a first portion of a first hand of a dentist's assistant supporting said tray member, said support member allowing the assistant to maintain said tray member in a substantially horizontal position, thereby maintaining the positions of the compounds disposed upon said tray member; and
a lever member secured to said cover member such that a second portion of the first hand of the dentist's assistant is allowed to engage said lever member to ultimately urge said cover member to open and closed positions while said first portion of the assistant's first hand supports said tray member via said support member, whereby a second hand of the assistant is free to manipulate other instruments while said cover member is maintained open by the first portion of the assistant's first hand until portions of the compounds are removed from said tray member, whereupon, said cover member is re-disposed to a closed positioned by the first portion of the assistant's first hand immediately after the portions of the compounds are removed from said tray member, thereby minimizing the quantity of light engaging the preselected compounds portions remaining on said tray member.

20. The device of claim 19 wherein said means for maintaining said cover member in an open position comprises:
a hook member joined to said cover member such that said cover member can be maintained in an open position when said hook member is urged to engage a cooperating retaining member joined to said tray member; and
a release lever joined to said hook member, said cover member ultimately being returned to a closed position when said release lever is manually urged in a general upward direction to ultimately separate said hook member and said retaining member, thereby allowing said cover member to re-engage said tray member.
